(19) United States
(12) Patent Application Publication
(10) Pub. No.: US 2010/0063904 A1
(43) Pub. Date: Mar. 11, 2010

(54) AUTOMATED TRAVEL LOG SYSTEM

(75) Inventors: Ittay Ronen, Shoham (IL); Rafael Moshe, Thornhill (CA)

Correspondence Address: The Law Office of Michael E. Kondoudis, 888 16th Street, N.W., Suite 800, Washington, DC, 20006, US

(73) Assignee: SATLOGIX INC., Thornhill, ON (CA)

(21) Appl. No.: 12/515,902

(22) PCT Filed: Nov. 7, 2007
(86) PCT No.: PCT/IL07/01353

§ 371 Date: May 21, 2009

(30) Foreign Application Priority Data
Nov. 30, 2006 (CA) 2569636
Sep. 10, 2007 (CA) 2597347

(51) Int. Cl. G06Q 10/00; G01S 19/41

(52) U.S. Cl. 705/30; 342/357.03; 342/357.07

(57) ABSTRACT

The invention is a tracking module for a vehicle operable to record business trips for producing mileage reports. The tracking module includes a processor, a power unit, a GPS receiver, operable to periodically determine the vehicle's location based upon GPS readings, a memory unit, and a transport interface, operable to connect to a base station and transmit the data records to the base station. Error correction is provided during periods of poor GPS reception using existing data records. The tracking module includes user input, operable to put the tracking module into a business mode while the tracking module is still in the vehicle wherein subsequent locations, the distance between the subsequent locations and the time of travel is logged in a data record and flagged as a business trip. From the base station, mileage reports can be edited and transmitted across the network to other financial servers.

### BACKGROUND OF THE INVENTION

Many vehicle owners use their vehicle for the purpose of conducting business. The travel is often tax deductible or reimbursed by the employer. In both cases, proper documentation is required to track the actual use of the vehicle for business purposes. This entails recording information about each trip, such as the beginning and end odometer reading, date and time, as well as destination and purpose of the trip. The recording of such information has to be done in a timely manner to comply with tax regulations and most employer requirements. The record keeping is commonly done using a manual paper based approach at the end of each travel day. The manual management of such a log is laborious, inaccurate and prone to abuse. In addition, the information is hard to verify. The end result is that most people do not keep an accurate vehicle trip log if at all.

Automated systems for tracking travel have been proposed. For example, U.S. Pat. No. 6,741,933 to Glass teaches a hardware mobile GPS unit that automatically tracks vehicle routes and mileage. The data is then transmitted to a base unit via a serial cable. A user then generates reports and visual maps of his or her travel.

US patent application teaches a system and a method for a mileage (or other distance measurement) logging apparatus (or portable mileage logger) is configured as an electronic device, which keeps track of the vehicle's mileage. The mileage logger is independent of the vehicle's electrical and sensor systems, although it may also be configured to tap a vehicle's power connection. The mileage logger is configured for portability. Hence, it can be transferred from one vehicle to another and removed from the vehicle without the need for disabling and rewiring. Moreover, the mileage logger may be configured with input/output ports to connect with a personal computer to download data from the apparatus. Alternative embodiments of the mileage logger may also be configured to include wireless network capabilities with an electronic mail protocol that allows for automatic wireless transmission of e-mailing capability to a user's computer, utilizing wireless network connections.

### SUMMARY OF THE INVENTION

It is an object of the invention to provide an automated, accurate, tamper proof, private and reliable vehicle trip log.

According to a first aspect of the invention, there is provided a tracking module for a vehicle operable to record business trips for the purpose of producing mileage reports, the tracking module comprising:

a processor;

a power unit;

a GPS receiver, operable to periodically receive GPS readings and determine the vehicle's location;

a memory unit, operable to store data records that include at least one of the periodic vehicle's location, the distance traveled between periodic locations, and the time when this travel between periodic locations took place;

a transport interface, operable to connect to a base station and transmit the data records to the base station;

at least one user input, operable to put the tracking module into a business mode wherein subsequent locations, the distance between the subsequent locations and the time of travel is logged in a data record and flagged as a business trip; and

wherein the tracking module is operable to reduce the effects of poor GPS readings by using previously stored data for error correction.

According to a second aspect of the invention, there is provided a system for tracking mileage in a vehicle used for business purposes comprising:

a tracking module comprising:
a processor;
a power unit;
a GPS receiver, operable to periodically determine the vehicle's location based upon GPS readings;
a memory unit, operable to store data records that include at least one of the periodic vehicle's location, the distance traveled between periodic locations, and the time when this travel between periodic locations took place;
a transport interface, operable to connect to transmit the data records; and
at least one user input, operable to put the tracking module into a business mode while the tracking module is still in the vehicle wherein subsequent locations, the distance between the subsequent locations and the time of travel is logged in a data record and flagged as business travel; and

a base station, operable to receive data records from the tracking module, and format the data records into a mileage report and then transmit the mileage report across a network.

### BRIEF DESCRIPTION OF THE DRAWINGS

Preferred embodiments of the present invention will now be described, by way of example only, with reference to the attached Figures, wherein:

FIG. 1a is a side profile view of a tracking module in accordance with a first embodiment of the invention;

FIG. 1b is a front profile view of the tracking module shown in FIG. 1a;

FIG. 1c is a perspective view of the tracking module shown in FIG. 1a;

FIG. 2 a schematic view of the tracking module shown in FIG. 1a;

FIG. 3 is a schematic view of a network operable to process and transmit information gathered from the tracking module shown in FIG. 1a;

FIG. 4 a schematic view of a tracking module shown according to another, non-limiting embodiment;

FIG. 5 a schematic view of a tracking module shown according to another, non-limiting embodiment;

FIG. 6 a schematic view of a tracking module shown according to another, non-limiting embodiment; and

FIG. 7 a schematic view of a tracking module shown according to another, non-limiting embodiment;

### DETAILED DESCRIPTION OF THE INVENTION

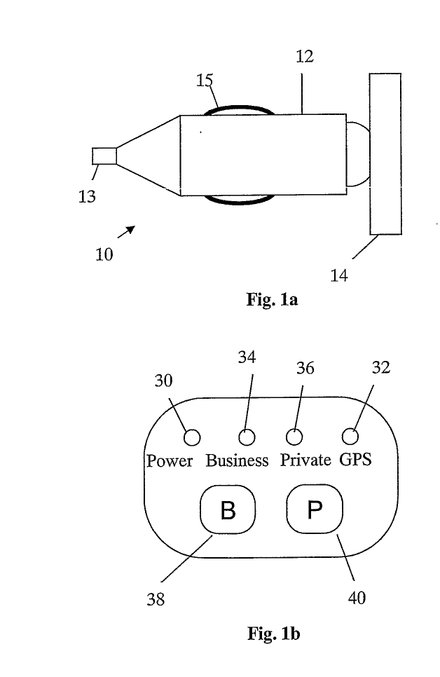

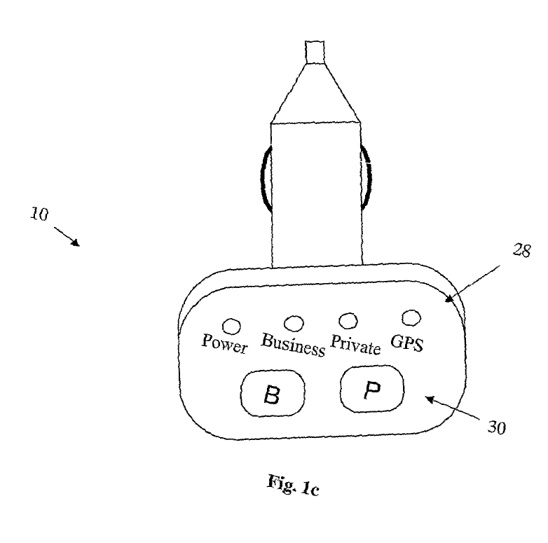

Referring now to FIG. 1a-1c, a tracking module is shown generally at 10. Tracking module 10 is a small portable electronic tracking module adapted for use in the owner's vehicle. It includes a cylindrical body portion 12 sized to be inserted into a vehicle's DC power outlet (not shown). A DC plug 13 is provided at one end of body portion 12, and an interface portion 14 is provided at the other end. A pair of resilient spring loaded side bars 15 provide a pressure locking mechanism. When tracking module 10 is placed in the vehicle's DC power outlet (i.e., the cigarette lighter), a pressure fit has to be twisted to simultaneously in order to make power contact. Once tracking module 10 is in place, the side bars 15 help prevent accidental disconnection. It is contemplated that tracking module 10 can include other form factors. For example, a ball joint could be used to provide a swivel functionality for interface portion 14. Alternatively, interface portion 14 could be offset from the end of the tracking module, thereby providing space for a power plug pass-through. Other variations in form factor will occur to those of skill in the art. Tracking module 10 could also be adapted to fit within a vehicle navigation system that provides a display to the driver. Tracking module 10 could also be a purely portable tracking module that relies upon a battery for power rather than being inserted into a DC power outlet. Alternatively, a fixed version could be connected directly to the vehicle's power supply (and hence, be less easily removed).

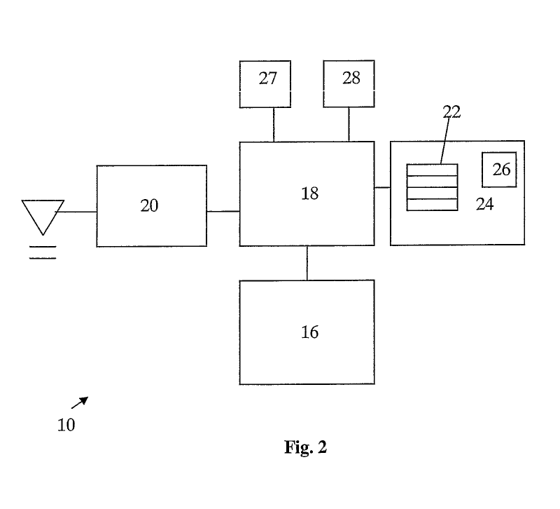

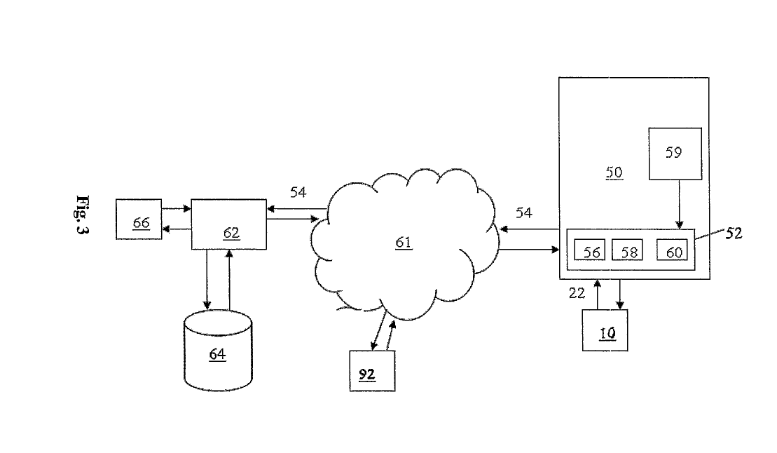

Within body portion 12 (FIG. 2) is a GPS receiver 16, a processor 18, and power unit 20. GPS receiver 16 is a self-contained global positioning system (GPS) that provides periodic position samples. Typically, GPS receiver 16 would gather position samples every second, but more or less frequent samples are possible. Processor 18 provides the intelligence for tracking module 10. It controls all the buttons and LEDs on interface portion 14 (described in greater detail below). In addition, processor 18 further logs position data received from GPS receiver 16 into data records 22 stored on a non-volatile memory unit 24. It is contemplated that while GPS receiver 16 could gather positional data every second, only a small subset of the positional data would be stored in memory unit 24 to conserve memory. For instance, one out of every sixty regular position samples could be stored. Position samples that indicate a change in direction would always be stored. In the event that memory unit 24 is full, new positional data will overwrite the oldest positional data. Processor 18 is further used to transfer data records 22 to a remote base station (described in greater detail below with reference to FIG. 3) using a transport interface 26, such as a USB port, 802.11, Bluetooth™ or a serial port. Other types of transport interface 26 will occur to those of skill in the art. Data transfer is described in greater detail below.

Interface portion 14 includes an indicator bank 27 and a button bank 28. Preferably, indicator bank 27 includes a plurality of LEDs operable to indicate the status of tracking module 10, along with the descriptive text adjacent to their respective LED. In the currently-illustrated embodiment, indicator bank 27 includes a power indicator 30 and a GPS active indicator 32 that is operable to indicate when GPS receiverGPS receiver 16 is receiving position data. Indicator bank 27 further includes a business indicator 34 and a private indicator 36, which show whether tracking module 10 is set in either business or private mode respectively. When traveling, only one of business indicator 34 or private indicator 34 will be active, depending on the state of tracking module 10. Business and private modes are described in greater detail below. Other indicators will occur to those of skill in the art. Alternatively, indicator bank 27 could include an LCD display.

Button bank 28 provides for at least one user input and in the current embodiment is a simple two-button interface having a business button 38 and a private button 40. Alternatively, a scroll input or 3×4 keypad could also be used.

Alternatively, in another non-limited embodiment, tracking module 10 could lack some or all of interface portion 14 entirely. Instead, tracking module 10 would interface with a display (not shown) already provided by the vehicle (such as a navigation panel or audio system panel) using an open interface such as FORD/SYNC™ or Bluetooth. In this case, tracking module 10 would be controlled using the input interface provided by the vehicle (such as buttons, touch screen or the like). The vehicle's display interface is used to display the current driving mode (business mode or private mode) and allow the user to change between travel modes.

Also alternatively, in another non-limiting embodiment, tracking module 10 could be spit into two components, the first being an input module and the second being a GPS receiver module (neither shown). The input module contains all the functionality of interface portion 14, namely receiving input commands through button bank 28, and outputting the state of tracking module 10 through indicator bank 27. Power to the input module would be provided by an onboard battery, or by the input module being connected to the vehicle's 12 V power line. The GPS receiver module would be placed elsewhere in the vehicle, preferably for optimal GPS signal reception. The GPS receiver module would be powered by onboard battery, a connection to the vehicle's power supply, or by solar panel. Communication between input module and GPS receiver module would be provided over RF, wire or data modulation over the vehicle's 12 V power line.

When tracking module 10 is plugged in, it is operable to track the vehicle's coordinates during travel as it takes periodic position readings using GPS receiverGPS receiver 16 and stores these locations in memory. By tracking the deltas between positions, tracking module 10 can determine when the vehicle is stationary or in motion, and calculate the distance traveled. Given the imprecision of commercial GPS systems, tracking module 10 could use multiple data positions to interpolate an actual direction and distance of travel. GPS receiverGPS receiver 16 is operable to bridge areas with bad GPS reception with approximating the distance based on known GPS readouts. When traveling through so called “urban canyons”, reflections from obstacles such as high-rise buildings may cause GPS receiverGPS receiver to incorrectly calculate the location of the vehicle. Such inaccuracies tend to be corrected in subsequent location readings when there is clear view of the sky. These corrections are usually manifested as jumps in the calculated location. For the purpose of distance calculations, such location jumps are ignored in distance calculations. The corrections in distance calculations can occur processor 18 in real time, or during post processing of data records 22 uploaded to a personal computer or central server (both described in greater detail below).

Tracking module 10 is also operable to discern when the vehicle is turned on or off by monitoring current flow through the vehicle's power outlet. In addition, tracking module 10 can calculate average travel speed between points. If desired, tracking module 10 can determine instances of excessive speeding or stopping.

Tracking module 10 defaults to either business mode or private mode depending on its configuration rules (described in greater detail below). The appropriate indicator 34 or 36 is illuminated. In addition, tracking module 10 emits one or two beeps to provide an audible reminder to the driver that the vehicle is in business or private mode, respectively. When business button 38 is pressed, tracking module 10 switches to business mode (illuminating business indicator 34 and deactivating private indicator 36). In business mode, tracking module 10 stores the following information in data records 22: trip mileage, start and end points and date and time of travel. When private button 40 is pressed (illuminating private indicator 36 and deactivating business indicator 34), tracking module 10 switches to private mode, tracking module 10 stores the trip mileage in data records 22, but does not track start and end points or time. Private indicator 26 is illuminated (and business indicator 24 is deactivated). Normally, tracking module 10 stays in its current mode (business or private) until manually switched to the other mode, or when the default rules change. However, when business button 38 is pressed and held for a longer period of time, tracking module 10 switches to a continuous business mode. When in continuous business mode, tracking module 10 does not switch to manual mode except through human intervention (by pressing private button 40). When private button 40 is pressed and held, tracking module 10 switches to a continuous private mode that does not track any information. Tracking module 10 does not switch to business mode expect by manual intervention (by pressing business button 38).

Normally, a new data record 22 is created for each trip, which can be defined as the distance traveled between presses of buttons 38 and 40, or between a button press and when the driver turns off the ignition or unplugs tracking module 10. Thus a trip from location A to location B would be stored in one data record 22, and the trip back from location B to location A would be stored as another data record 22. A data record 22 is also created whenever tracking module 10 is connected or disconnected from the vehicle's power supply. In addition to the data recorded from GPS receiverGPS receiver 16, each data record 22 contains an unique identifier associated with the specific tracking module 10 (i.e., each individual tracking module 10 will have its own unique identifier) that is unmodifiable by the user.

It is contemplated that data records 22 could provide a “sign in/sign out” functionality. Most time and attendance systems are used at a fixed site. Employees sign in and sign out, and these timed events used to calculate compensation. For mobile employees that travel between locations, such a determination is difficult. For mobile employees, switching the tracking module 10 into and out of business mode would indicate sign in and sign out times. The first activation of business mode during the day would indicate signing in and the last switch to private mode in a day would indicate signing out. Data records 22 would include date stamps and GPS locations that could later be verified, if required. Alternatively, the GPS could automatically create sign in and sign out events in data records 22 whenever the vehicle left or arrived at a particular, predefined location or locations.

It is contemplated that some businesses may wish to permanently associate each tracking module 10 with a specific vehicle. Identifying the vehicle can be done by placing a small passive ID in the vehicle that is not easily accessible by the driver. For example, the passive ID can be placed in the DC power outlet (not shown) that interfaces directly with DC plug 13. Alternatively, the passive ID can be located near the vehicle's engine and transmit the identifier data over the 12V DC power. Each passive ID would transmit a unique vehicle identifier that is appended to each data record 22. For businesses that have fleet vehicles that may be shared between different drivers, a tracking module 10 can be modified as to log who is driving the vehicle. A default user is normally included for each data record 22, but that user can be changed by using a unique driver ID placed in a proximity RF card or a unique ID button. In this case, the unique driver identifier is appended to each data record 22.

As discussed earlier, data records 22 can be transferred from transport interface 26 to a mobile base station, which is typically a personal computer (PC), indicated at 50 in FIG. 3. Depending on the method used, the uploading of data records 22 may be done with tracking module 10 still attached to the vehicle. Methods of data include: a direct serial interface or USB cable connected to PC 50, a wireless transfer to PC 50 using 802.11, Bluetooth or ZigBee wireless protocol, or transfer via a cell phone (connected by a serial interface, USB or Bluetooth) and routed through a network to PC 50. If desired, data records 22 could include a unique ID provided by the tracking module 10 (or even by the optional passive ID system) to reduce fraudulent mileage reports. For greater security, data records 22 could be encrypted using the unique ID as the encryption key. Additionally, the tracking module 10 could require that a password is transmitted from PC 50 before downloading the data records 22 to the PC.

PC 50 runs mileage software 52, which is responsible for gathering data records 22 and producing mileage reports 54. Mileage software 52 includes an upload module 56, a software program or service operable to establish connectivity with tracking module 10. Connectivity can be established using any standard medium and protocol, such as wired or wireless TCP/IP, Bluetooth, SMS or a serial connection. Other protocols and mediums will occur to those of skill in the art. Once a connection is established, upload module 56 can download the data records 22 from tracking module 10, as well as clear the storage memory of tracking module 10 as necessary. For instance, if a tracking module 10 is passed from one employee to another, the new employee will want to start with a clean slate. Also, mileage software 52 can provide any post-processing required of data records 22. For example, location jumps in positional data (described above) can be removed from trip distance calculations.

Mileage software 52 also runs a configuration manager (CM) 58 that is operable to define the configuration rules for tracking module 10. Using CM 58, the driver could set the configuration rules so that tracking module 10 automatically defaulted to business mode, personal mode, or the previous mode. More sophisticated configuration rules are also possible. For instance, the driver could set the configuration rules so that tracking module 10 would always be in business mode Monday to Friday from 9:00 to 5:00, and private mode for the remainder of the week. A dynamic learning algorithm based on historical trip mode information correlation to time of day and day of week can also be used to set configuration rules without requiring manual definition. Other configuration rules are within the scope of the invention.

Mileage software 52 also includes a mileage-reporting module (MRM) 60 that processes data records 22 received by UM 56 and formats them into a mileage reports 54. MRM 60 is operable to generate time-based textual and graphic reports representing vehicle travel for business purpose. Travel information included in the reports can include: Origin, Destination, Stop Points, Distance traveled, Start Time, End Time, Calendar event, as well any user-provided comments. Preferably, MRM 60 can also plot travel destinations over a period of time on graphical maps. If available, MRM 60 can receive map data from route planning software 92 (described in greater detail below). Using MRM 60, the driver is also able to add notes or make corrections to their records (say if a trip was inadvertently logged as business rather than private).

Also using MRM 60, the driver can delete stop points that are marked as private. For example, the driver may delete where he or she stopped for lunch from mileage report 54. Optionally, MRM 60 could be configured to delete stop points of up to a predetermined length. Alternatively, MRM 60 could be configured so that all points between the Origin and the Destination are considered “intermediary” stop points, and will not be included in a mileage report 54.

Optionally, some stop points can be permanently associated with a business trip, or a private trip. For example, the driver might designate his or her child's school as always being, by default, a private trip, while a trip to a regular customer site would be considered, by default, a business trip. In this fashion, repetitive data entry is reduced or eliminated. Preferably, locations having a default status as always business or always private can also include more specific labels such as “ABC warehouse”, or the like, to provide more details to the mileage report 54. Certain regions can also be restricted to either business or private, by default. For example, trips made out of state or province could be considered private as they are outside of the driver's sales territory.

In addition, a particular numeric code may be entered by the user to indicate that a particular business trip is associated with a specific customer number, billing code or cost center. This code is reported as part of the trip data for reconciliation with the billing and payment system. Manual changes will be permanently logged as changed so that auditors can follow up and investigate mileage reports 54 that include manual changes.

Also preferably, MRM 60 is operable to augment data records 22 with supplemental information, such as correlated business calendar activities from external calendar application 59. Calendar information can be imported using any standard format such as iCal or a CSV. Thus, trip information can be appended with data such as the purpose and location stored in the calendar event. By default, data records 22 would be automatically augment with the calendar event with the closest matching time (plus or minus an hour), but more sophisticated association rules could also be used. Calendar events that are marked as private would be ignored. A user could also manually augment their data records 22 with calendar events. In addition to augmenting data records 22 with correlated events, MRM 60 could import other supplemental information such as contact names and addresses drawn from the user's address book based on proximity to the destination stop. When MRM 60 imports information from external applications, users will be able to correct incorrect inferences.

Once users are satisfied, the user can transmit their mileage reports 54 over a network 61 to a process management module (PMM) 62 which is typically running on a remote server. Network 61 is typically an IP based network, and can include both private IP networks and the general Internet. PMM 62 handles the approval of business travel for payment. PMM 62 can receive travel reports 54 in a number of ways, including email, email attachments or through direct file uploading. PMM 62 also handles (typically via email), any automated requests for report clarifications on exceptional events, notification of approving authorities of pending approval requests and analysis tools to assist in the review of travel approval requests which include: out-of-range travel, out of business time travel, high speed travel, excessive idle time, and excessive private travel during business hours. In addition PMM 62 handles the notification to the traveler of approval, partial approval or denial of their mileage reports 54. Mileage reports 54 are stored in a travel log database 64. Once stored in database 64, mileage reports 54 can be later data-mined and analyzed for trends and possible fraudulent activity.

The financial interface module (FIM) 66 is used to calculate the dollar value of business travel. In addition, FIM 66 schedules the export of payment information and interfaces to corporate accounting and resource planning package (not shown). FIM 66 is also operable to assign travel expenses to the appropriate expense accounts, and handle any other back-end processing. FIM 66 could also include a table of tariff rates, determined by either time of day, or calendar date. For example, a higher rate could be charged for business mileage accrued at night, or over weekends. Different tariff rates could also be determined by geographical area. For instance, a traveler driving through different countries of the European Union would face different gas taxes in each country. By associating datapoints with specific tariff regions, a more detailed payment calculation could be made. Some regions could have a tariff rate of zero, indicating that no travel in this region will be considered a compensatible business trip.

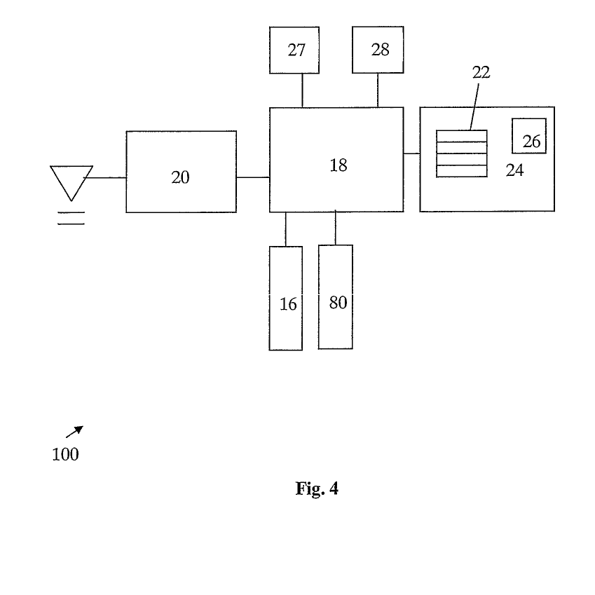

It is contemplated that several adaptations can be made to different embodiments of the invention. Referring now to FIG. 4, in an alternate, non-limiting embodiment of the invention, tracking module 100 could be equipped with a direction-indicating device 80 such as a gyroscope or compass. Processor 18 could compare the readings from the direction-indicating device 80 to the direction of travel determined from GPS receiverGPS receiver 16. If processor 18 detects an angular disparity between the two readings, poor GPS tracking could be detected. When a poor GPS tracking event is logged for a specific positional data point (i.e., an inaccurate GPS reading, an incomplete GPS reading, or no GPS reading), that data point would be considered suspect, and given less weight when travel distance is calculated (either within tracking module 10) or after the data has been downloaded to either PC 50 or PMM 62.

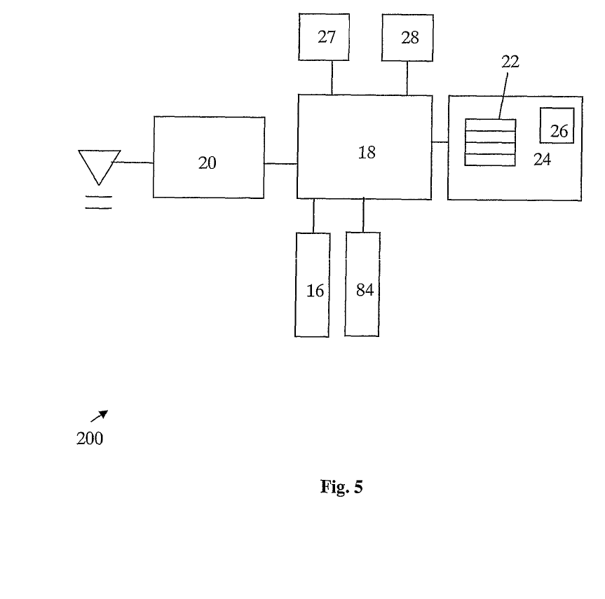

Referring now to FIG. 5, in another, non-limiting embodiment of the invention, a tracking module 200 could be equipped with an accelerometer 84. In cases of poor GPS reception, processor 19 could use a measurement of linear acceleration and/or deceleration from accelerometer 84 to calculate the distance traveled between points. Since accelerometers have inherent drift, tracking module 10 would recalibrate accelerometer 84 every time the vehicle is stopped.

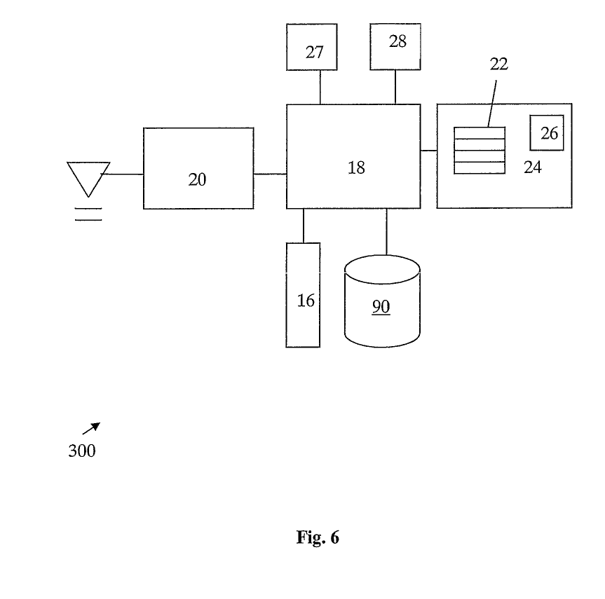

Referring now to FIG. 6, in another alternate, non-limiting embodiment of the invention, a tracking module 300 includes a compact database 90 of GIS coordinates. Compact database 90 would be a database of street coordinates for major urban centers where “urban canyon” and multipath effects reduce the quality of GPS reception significantly i.e., inaccurate GPS readings, incomplete GPS readings, or no GPS readings). The storage requirements of compact database 90 are significantly reduced over a traditional full-coverage GIS location database, but compact database 90 is still operable to correct GPS readings to correspond to the correct street coordinates, thereby reducing the likelihood of wrong location readings due to building reflections.

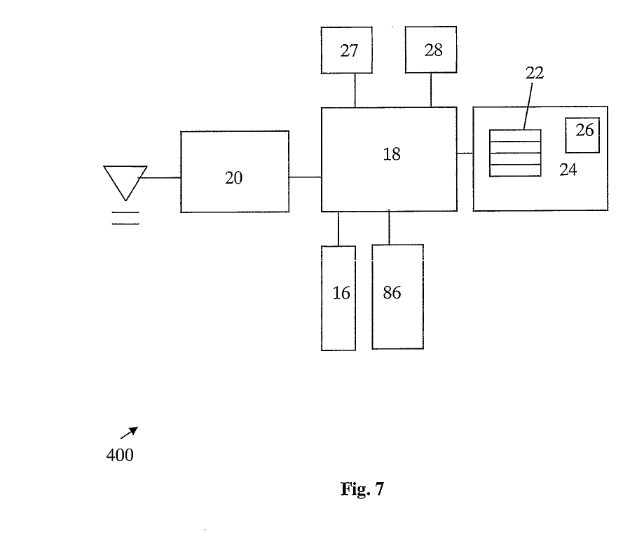

Referring now to FIG. 7, in another alternate, non-limiting embodiment of the invention, a tracking module 400 is operable to receive supplemental vehicle data through an input device 86. Input device 86 is operable to receive vehicle data such as odometer reading changes through a data feed like OBDII. The supplemental data would be used to assist in the calculations of trip distances by processor 18. Connectivity to OBDII port can be wired, wireless, or data signal modulation over the vehicle's 12V power line.

In another non-limiting embodiment, processor 18 is operable to calculate a vehicle's location even under conditions of poor reception. In cases where GPS receiverGPS receiver 16 does not get an immediate position fix (i.e., an inaccurate GPS reading, an incomplete GPS reading, or no GPS reading), but later receives a fixed location within a predetermined distance threshold from the last stop point, tracking module 10 could use the last stop point as the new starting point.

As is known to those of skill in the art, GPS systems receive GPS ephermis data from GPS satellites periodically. It has become apparent to the inventors that if a GPS receiver is not powered for several hours, or if it is in an area of bad reception, the receiver's ephermis data may become stale. In such a state, known prior art GPS receivers cannot provide an accurate GPS reading even if it can still receive the satellite signal.

In contrast, in another non-limiting embodiment, tracking module 10 includes several techniques for dealing with stale ephermis data or insufficient signal strength. In situations where tracking module 10 can still receive a GPS signal, it can store the raw satellite data in data records 22. The data records 22 can be subsequently completed whenever the GPS receiverGPS receiver 16 regains sufficient reception to download current ephermis data. Processor 18 is then able to post-process the raw readings stored in data records 22 going back to the beginning of travel period having stale ephermis data. Preferably, this technique is used only when the ephermis data is received no later than a particular time threshold.

Alternatively, in situations where GPS receiver 16 cannot acquire current ephermis data, processor 18 can calculate locations using stored ephermis data from either 12 or 24 hours earlier. For distance-logging purposes, this earlier ephermis data would be sufficient for most users. Less preferably, processor 18 could calculate rough locations using stored GPS almanac data. As is known to those of skill in the art, almanac data stays valid for several weeks. Since location is only important in relative terms to calculate distance of travel, this is sufficient in most cases. This method takes into account potential location jumps when changing the satellites used for location calculation. Such jumps are ignored in distance calculation.

Alternatively, when tracking module 10 uses stale ephermis data or Almanac data, more accurate locations can be determined through post-processing. Data records 22 would contain inaccurate or incomplete GPS readings. Once data records 22 are downloaded to PC 50, PC 50 can receive the correct ephermis data (correct for the trip time), and calculate more accurate records using the rougher GPS locations stored in data records 22 or raw data stored in data records 22.

Alternatively, PC 50 can perform post-processing using route planning software 92 to improve the accuracy of tracking module 10 by correcting for location jumps and other artifacts created by poor GPS data. As known to those of skill in the art, online route planning software 92, such as MapQuest™ or Google Maps™ can calculate trip distances over normal roadways when given a starting point and an ending point. Route planning software 92 can run locally on PC 50 (not shown), or be accessed remotely over network 61 (FIG. 3). Recorded GPS locations stored in data records 22 can be compared to the road maps available in the route planning software 92. GPS readings that correspond to road locations can be considered trusted GPS readings, and GPS readings that deviate from the road can be corrected so that the plotted route aligns with the road map.

Alternatively, since data records 22 contain the starting point and ending point of trips, a reasonable route of a trip can be determined. PC 50 can simply input the starting points and ending points into the route planning software 92. Route planner software 92 will provide an estimated trip distance. The estimated trip distance determined by route planning software 92 can be compared to the distances logged by GPS receiver 16. If the difference between the two distances is within a predefined threshold (say 10%), then the distance determined by the GPS receiver 16 will be used for mileage reports 54. If the difference between the two distances exceeds this threshold (typically indicating either poor GPS tracking or excessive side trips), then the distance determined by the route planner software 92 will be used for mileage reports 54.

Although various preferred embodiments of the present invention have been described in detail, it will be appreciated by those skilled in the art that variations may be made without departing from the spirit of the invention, the scope of which are defined by the claims.

What is claimed is:

1. A tracking module for a vehicle operable to record business trips for the purpose of producing mileage reports, the tracking module comprising:
a processor;
a power unit;
a GPS receiver, operable to periodically receive GPS readings and determine the vehicle's location;
a memory unit, operable to store data records that include at least one of the vehicle's periodic location, a distance traveled between periodic locations, and the time when this travel between periodic locations took place;
a transport interface, operable to connect to a base station and transmit the data records to the base station;
at least one user input, operable to put the tracking module into a business mode wherein subsequent locations, the distance between the subsequent locations and the time of travel is logged in a data record and flagged as a business trip; and
wherein the tracking module is operable to reduce the effects of poor GPS readings by using previously stored data for error correction.

2. The tracking module of claim 1, wherein the processor is operable to calculate trip distances between two points when at least one intermediary point has a bad GPS readings by calculating the distance between known GPS readings.

3. The tracking module of claim 1, wherein the at least one user input is further operable to put the tracking module into at least one of:
a private mode while the tracking module is still in the vehicle wherein the distance between at least two subsequently determined locations is tracked but the locations themselves and the time of travel are not recorded in the data record;
a permanent private mode while the tracking module is still in the vehicle wherein the tracking module does not record any subsequent distances, locations or travel times; and
a permanent business mode wherein all subsequently determined locations, distances and times are recorded and flagged as business travel.

4. The tracking module of claim 3, wherein the tracking module automatically selects one of business mode, private mode, permanent business mode and permanent private mode based upon a set of predetermined configuration rules prior to receiving any manual inputs from the at least one user input.

5. The tracking module of claim 4, where in the predetermined configuration rules includes selecting the one of business mode, private mode, permanent business mode and permanent private mode based one of upon the day of the week, time of the day and predetermined location.

6. The tracking module of claim 5, where in the predetermined configuration rules can be set on the base station and transmitted to the tracking module when the two are connected.

7. The tracking module of claim 6, wherein the predetermined configuration rules can be set by the base station using a dynamic learning algorithm based upon the data records historically received from the tracking module.

10. The tracking module of claim 1, wherein the tracking module receives a unique driver ID from a transponder operable to be carried by each driver for the vehicle, and adds the unique driver ID to the data records.

11. The tracking module of claim 1, wherein the at least one user input provides a “sign-in” event and a “sign-out” event for business purposes.

12. The tracking module of claim 1, wherein the GPS receiver is providing inaccurate GPS readings that indicate location jumps, the tracking module ignoring the location jumps when calculating the distance between periodic locations.

13. The tracking module of claim 1, wherein the tracking module is operable to determine a vehicle's location using supplemental information when the GPS receiver is providing one of: inaccurate GPS readings, incomplete GPS readings and no GPS readings.

14. The tracking module of claim 13, wherein the supplemental information includes data from at least one of a gyroscope, a compass, an accelerometer and an odometer.

15. The tracking module of claim 13, wherein the supplemental information includes a compact GIS database.

16. The tracking module of claim 13, wherein the tracking module is operable to store at least one of inaccurate GPS readings, incomplete readings and no GPS readings in the data records, and subsequently transmit the data records to the base station for calculating trip distances.

17. The tracking module of claim 13, wherein the supplemental information includes stale GPS ephermis data.

18. The tracking module of claim 17, wherein the stale GPS ephermis data is one of a last known GPS ephermis data, twelve hours old GPS ephermis data and twenty-four hours old ephermis data.

19. The tracking module of claim 17, wherein the vehicle location previously determined using stale GPS ephermis data is recalculated after accurate GPS ephemeris data is received.

20. The tracking module of claim 17, wherein the vehicle location previously determined using stale GPS ephermis data is recalculated by the tracking module once the tracking module receives current GPS ephermis data.

21. The tracking module of claim 20, wherein the vehicle location previously determined using stale GPS ephermis data is recalculated only when the current GPS ephermis data is received within a predetermined length of time from previously calculating the vehicle location using the stale GPS ephermis data.

22. The tracking module of claim 14, wherein the supplemental information includes GPS almanac data.

23. The tracking module of claim 14, wherein the supplemental information includes the last known vehicle position.

24. The tracking module of claim 23, wherein the last known vehicle location is determined to be a stopping point, the last known vehicle position is determined to be a starting point.

25. A system for tracking mileage in a vehicle used for business purposes comprising:
a tracking module comprising:
a processor;
a power unit;
a GPS receiver, operable to periodically determine the vehicle's location based upon GPS readings;
a memory unit, operable to store data records that include at least one of the vehicle's periodic location, a distance traveled between periodic locations, and the time when this travel between periodic locations took place;
a transport interface, operable to connect to transmit the data records; and
at least one user input, operable to put the tracking module into a business mode while the tracking module is still in the vehicle wherein subsequent locations, the distance between the subsequent locations and the time of travel is logged in a data record and flagged as business travel; and
a base station, operable to receive the data records from the tracking module, and format the data records into a mileage report and then transmit the mileage report across a network.

26. The system of claim 25, further comprising a central server, operable to receive mileage reports over the network.

27. The system of claim 26, wherein a user is operable to import supplemental information from other software on the base station and augment the data records used in the mileage report with the supplemental information.

28. The system of claim 27, wherein the supplemental information includes at least one of: scheduling information received from a calendar application, contact names and contact addresses.

29. The system of claim 28, wherein the base station can automatically correlate scheduling information with recorded trip times stored in the data records.

30. The system of claim 27, wherein the user is operable to associate a particular trip with a specific billing code.

31. The system of claim 27, wherein the user is operable to generate a map of trips taken based upon the locations stored in the data records.

32. The system of claim 31, wherein the user is operable to manually correct the mileage report at the base station prior, to transmitting it to the central server.

33. The system of claim 32, wherein the central server is operable to at least one of calculate a mileage portion of expense reports based upon a received mileage report, approve the mileage portion of expense reports, and automatically forward the mileage report to at least one person designated to approve expense reports.

34. The system of claim 25, further comprising route planning software operable to provide an estimated trip distance between a starting point and an ending point provided by the data records, and wherein
the base station is operable to compare the estimated trip distance with the distance calculated for a business trip by the tracking module and when a difference is determined between the estimated trip distance and the distance calculated for the business trip by the tracking module exceeds a predetermined threshold.

35. A method of tracking mileage in a vehicle used for business purposes, comprising:
placing a tracking module in the vehicle, the tracking module being operable to periodically determine the vehicle's location and store data records that include at least one of the vehicle's periodic location, a distance traveled between periodic locations, and the time when this travel between periodic locations took place;
placing the tracking module into a business mode using at least one user input while the tracking module is within the vehicle, wherein subsequent locations, the distance between the subsequent locations and the time of travel is logged in a data record and flagged as business travel;
transmitting data records to a base station, the base station being operable to receive the data records from the tracking module, format the data records into a mileage report; and
correcting the effects of poor GPS readings using previously stored data in one of the tracking module and the base station.

36. The method of claim 35, further comprising:
transmitting the mileage report across a network; and
receiving the mileage report at a central server, the central server operable to process the mileage report for accounting purposes.

37. The method of claim 36, further comprising:
importing supplemental information from other software on the base station and augmenting the data records used in the mileage report with supplemental information,
wherein the supplemental information includes at least one of: scheduling information received from a calendar application, contact names and contact addresses.

38. The method of claim 37, further comprising:
automatically correlating scheduling information with recorded trip times stored in the data records at the base station.

39. The method of claim 37, further comprising at least one of:
manually associate a particular trip with a specific billing code, manually correcting the mileage report at the base station prior to transmitting it to the central server, and
having the mileage report indicate all manual changes made prior to transmitting it to the central server.

40. The method of claim 36, further comprising at least one of:
calculating a mileage portion of expense reports based upon received mileage reports at the central server and
approving the mileage portion of expense reports at the central server.

41. The method of claim 35, wherein the tracking module is operable to determine the vehicle's location using a GPS receiver.

42. The method of claim 41, wherein the data records indicate location jumps, the location jumps are ignored when calculating distances for the mileage report.

43. The method of claim 42, wherein the tracking module is operable to store at least one of inaccurate GPS readings, incomplete GPS readings and no GPS readings in the data records and are corrected using supplemental information when calculating distances for the mileage report.

44. The method of claim 43, wherein the supplemental information includes data from at least one of a gyroscope, a compass, an accelerometer and an odometer.

45. The method of claim 43, wherein the supplemental information includes a compact GIS database located on the tracking module.

46. The method of claim 43, wherein the supplemental information includes stale GPS ephemeris data.

47. The method of claim 46, wherein the stale GPS ephermis data is one of the last known ephemeris data, twelve hours old ephermis data and twenty-four hours old ephermis data.

48. The method of claim 46, wherein the vehicle's location determined using stale GPS ephermis data is recalculated after accurate GPS ephemeris data is received.

49. The method of claim 48, wherein the vehicle's location determined using stale GPS ephermis data is recalculated in the tracking module once the tracking module receives current GPS ephermis data, when the current GPS ephermis data is received within a predetermined length of time from calculating the vehicle's location using the stale GPS ephermis data.

50. The method of claim 48, wherein the vehicle's location determined using stale GPS ephermis data is recalculated in one of the base station and a central server once one of the base station and the central server receives the then current GPS ephermis data for when the vehicle's location was calculated, and recalculates the vehicle's location using the then current GPS ephermis data for when the vehicle's location was calculated.

51. The method of claim 43, wherein the supplemental information includes GPS almanac data.

52. The method of claim 43, wherein the supplemental information includes the last known vehicle position.

53. The method of claim 52, wherein the last known vehicle position is determined to be a stopping point, the last known vehicle position is determined to be a starting point.

54. The method of claim 35, calculating an estimated trip distance between a starting point and an ending point provided by the data records using route planning software, and comparing the estimated trip distance with the distance calculated for a business trip by the tracking module and when a difference is determined between the estimated trip distance and the distance calculated for the business trip by the tracking module exceeds a predetermined threshold.
